(19) United States
(12) Patent Application Publication
(10) Pub. No.: US 2006/0099022 A1
(43) Pub. Date: May 11, 2006

(54) PRINTER CAPABLE OF DETECTING STATUS OF UNUTILIZED RIBBON

(76) Inventor: Kuang-Huei Huang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 10/906,802

(22) Filed: Mar. 8, 2005

(30) Foreign Application Priority Data
Nov. 10, 2004 (TW) 093134297

(51) Int. Cl. B41J 31/09

(52) U.S. Cl. 400/237

(57) ABSTRACT

A printer includes a ribbon supply end, a ribbon retrieving end, and a ribbon. The two ends of the ribbon are installed on the ribbon supply end and the ribbon retrieving end respectively. The printer further includes a print head, a driving module for driving the ribbon supply end and the ribbon retrieving end so as to move the ribbon from the ribbon supply end to the ribbon retrieving end, a light source for emitting light, an optical sensor installed in the position that the optical sensor can sense the light emitted from the light source when the thickness of the remaining ribbon on the ribbon supply end is less than a predetermined value, and a control module for controlling the printer according to whether the optical sensor can sense the light emitted from light source.

### BACKGROUND OF INVENTION

1. Field of the Invention

The present invention relates to a printer capable of detecting the status of unutilized ribbon, more particularly, to a printer capable of utilizing a light sensor to detect the status of unutilized ribbon.

2. Description of the Prior Art

A printer has become an essential output device in our information age. A traditional printer prints data onto a piece of paper or a print medium. As information technology advances, printers nowadays come with a variety of functions. For example, a thermal printer is capable of printing an image directly from a digital camera onto a piece of paper, the advantage is that a user can choose to print a favorite image or photograph and discards the rest. Therefore wasting resources and money to develop a full roll of traditional negatives to print photographs is avoided. The current thermal printer, utilizes a thermal print head to print documents, includes a paper drawer for placing print material such as paper, and an imaging material cassette for placing imaging material such as ink film or ribbon.

The thermal printer and an ink jet printer have very similar frameworks, however, one difference being that the ink jet printer requires liquid ink whereas the thermal printer utilizes a solid ribbon. Another difference is that most ink jet printers utilize a half tone printing method; they are unable to print continuous tone of a real life photograph. Hence, the thermal printer that has a continuous tone function is becoming more popular among consumers. The thermal printer utilizes a sublimation technique to apply colors of the transfer ribbon directly onto the paper; the ribbon is a transparent cellular paper that includes dye. During the process of printing, the thermal print head heats up the ribbon's dye. The melted color will be transferred from the ribbon onto the paper. Later when the color on the paper cools a colored image will be displayed.

In general, to ensure that there is sufficient ribbon for the next printout, there is a need to detect if the ribbon is reaching its end. In determining a conventional group of ribbon, a special barcode is added to the ribbon for the optical sensor to differentiate. Please refer to FIG. 1. FIG. 1 illustrates a perspective view of a ribbon apparatus of a conventional color printer 10. As shown in FIG. 1, the ribbon apparatus of the color printer 10 comprises a ribbon 12, two light sources 14, 16, and two sensors 18, 20. The ribbon 12 comprises a plurality of sequentially arranged dye regions 22. Each dye region 22 comprises four different color dye areas 24, 26, 28, 30 for placing yellow dye, magenta dye, cyan dye, and overcoating dye. An opaque dividing section 32 is located before a yellow dye area 24. A semi-opaque dividing section 34 and a transparent dividing section 36 are located between the dye areas 24 and 26, 26 and 28, 28 and 30. The light sources 14, 16 are located on one side of the ribbon 12 and produce light beams 38, 40 of two predetermined colors. The sensors 18, 20, corresponding to the light sources 14, 16, are located on the opposite side of the ribbon 12. The sensors 18, 20 are utilized to detect light beams 38, 40 penetrating through the ribbon 12 and produce corresponding signals to determine the position of the ribbon 12. The detection of an opaque dividing section 32 signals the beginning position of a new dye region 22 of the ribbon 12, and also corresponds to the beginning position of a yellow dye area 24. The detection of a semi-opaque dividing section 34 and a transparent dividing section 36 by the sensors 18, 20 corresponds to the beginning position of the magenta dye area 26, cyan dye area 28, or overcoating dye area 30. In the above-mentioned, a special barcode is added to the opaque dividing section 32 before a group of dye area 22 on the ribbon 12. The detection of the special barcode signals a last unused dye area 22 and to remind the user to replace the existing ribbon 12. In this method of detecting ribbon, the special barcode is needed to place in between each dye area, and it decreases the effective utilization of the ribbon 12, resulting in higher production costs of the ribbon 12.

### SUMMARY OF INVENTION

The claimed invention relates to a printer capable of utilizing a light sensor to detect the status of unutilized ribbon to solve the problem mentioned above.

One embodiment of the claimed invention is a printer capable of detecting the status of unutilized ribbon, the printer comprising: a ribbon supply end; a ribbon retrieving end; a ribbon wherein two ends are installed on the ribbon supply end and the ribbon retrieving end respectively; a print head for printing dye on the ribbon onto a print medium; a driving module for driving the ribbon supply end and the ribbon retrieving end, and to move the ribbon from the ribbon supply end to the ribbon retrieving end; a light source for emitting light; an optical sensor installed in a position where the optical sensor can sense the light emitted from the light source when the thickness of the remaining ribbon on the ribbon supply end is less than a predetermined value and also the optical sensor installed in a position where the optical sensor cannot sense the light emitted from the light source when the thickness of the remaining ribbon on the ribbon supply end is greater than the predetermined value; and a control module for controlling the printer according to whether the optical sensor can sense the light emitted from the light source.

One embodiment of the claimed invention includes a method of controlling a printer, the method comprising the following steps: supplying a light source; a sensor installed in a position where the sensor can sense the light emitted from the light source when the thickness of the remaining ribbon on the ribbon supply end is less than a predetermined value and the sensor cannot sense the light emitted from the light source when the thickness of the remaining ribbon on the ribbon supply end is greater than the predetermined value; and controlling the printer according to whether the optical sensor can sense the light emitted from the light source.

Another embodiment of the claimed invention is a printer capable of detecting status of unutilized ribbon, the printer comprising: a ribbon supply end; a ribbon retrieving end; a ribbon wherein two ends are installed on the ribbon supply end and the ribbon retrieving end; a print head for printing dye on the ribbon onto a print medium; a driving module for driving the ribbon supply end and the ribbon retrieving end, and to move the ribbon from the ribbon supply end to the ribbon retrieving end; a light source for emitting light; an optical sensor installed in a position where the optical sensor cannot sense the light emitted from the light source when the thickness of the retrieved ribbon on the ribbon retrieving end is greater than a predetermined value and also the optical sensor installed in a position where the optical sensor cannot sense the light emitted from the light source when the thickness of the retrieved ribbon on the ribbon retrieving end is less than the predetermined value; and a control module for controlling the printer according to whether the optical sensor can sense the light emitted from the light source.

Another embodiment of the claimed invention includes a method of controlling a printer, the method comprising the following steps: supplying a light source; a sensor installed in a position where the sensor can sense the light emitted from the light source when the thickness of the remaining ribbon on the ribbon retrieving end is less than a predetermined value and the sensor cannot sense the light emitted from the light source when the thickness of the remaining ribbon on the ribbon supply end is greater than the predetermined value; and controlling the printer according to whether the optical sensor can sense the light emitted from the light source.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a perspective view of a ribbon apparatus of a conventional color printer.

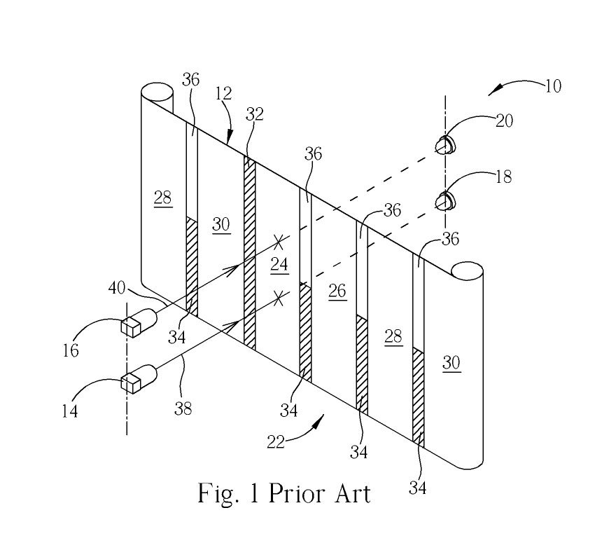

FIG. 2 illustrates a functional diagram of a printer capable of detecting status of utilized ribbon.

FIG. 3 illustrates an internal architectural diagram of the printer with sufficient ribbon.

FIG. 4 illustrates an internal architectural diagram of the printer without sufficient ribbon.

FIG. 5 illustrates an internal architectural diagram of the printer with sufficient ribbon according to the second embodiment of the present invention.

FIG. 6 illustrates an internal architectural diagram of the printer without sufficient ribbon according to the second embodiment of the present invention.

### DETAILED DESCRIPTION

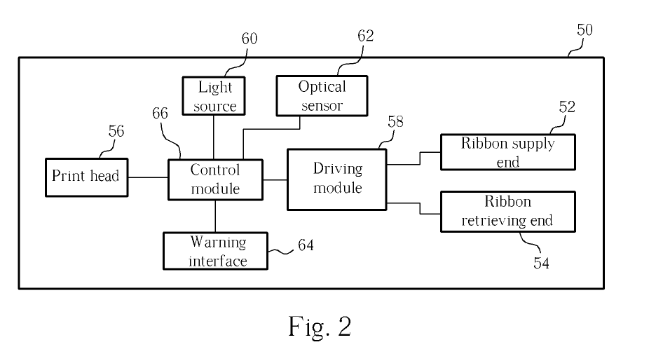

Please refer to FIG. 2. FIG. 2 illustrates a functional diagram of a printer capable of detecting status of unutilized ribbon. The printer 50 can be a thermal printer. The printer 50 comprises a ribbon supply end 52 which can be a roller, a ribbon retrieving end 54 which can also be a roller, a ribbon wherein two ends are installed on the ribbon supply end 52 and the ribbon retrieving end 54 respectively, a print head 56 for printing dye on the ribbon onto a print medium, a driving module 58 for driving the ribbon supply end 52 and the ribbon retrieving end 54 and to move the ribbon from the ribbon supply end 52 to the ribbon retrieving end 54, a light source 60 for emitting light which can be a light emitting diode (LED), an optical sensor 62 installed in a position where the optical sensor 62 can sense the light emitted from the light source when the thickness of the remaining ribbon on the ribbon supply end 52 is less than a predetermined value and also the optical sensor 62 installed in a position where the optical sensor 62 cannot sense the light emitted from the light source when the thickness of the remaining ribbon on the ribbon supply end 52 is greater than the predetermined value, a warning interface 64 for displaying a warning signal which can be a warning light or a beeper and a control module 66 for controlling the printer according to whether the optical sensor 62 can sense the light emitted from the light source 60 and also to control the warning interface 64 to display a warning signal when the optical sensor 62 senses the light emitted from the light source.

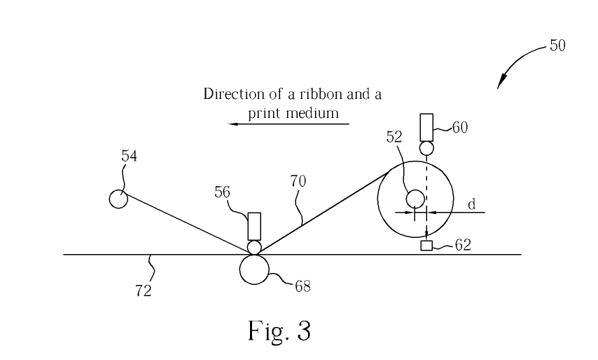

Please refer to FIG. 3. FIG. 3 illustrates an internal architectural diagram of the printer 50 with sufficient ribbon. The printer 50 further comprises a platen roller 68 with the print head 56 before executing a printout, clamping onto the ribbon 70 and the print medium 72. The ribbon 70 and the print medium 72 move according to the direction pointed in the diagram. The ribbon 70 is moved from the ribbon supply end 52 to the ribbon retrieving end 54, the ribbon of the ribbon supply end 52 will become less and the ribbon of the ribbon retrieving end 54 will become more which also means that thickness of the ribbon on the ribbon supply end 52 will become thinner and the thickness of the ribbon on the ribbon retrieving end 54 will become thicker. The light source 60 and the optical sensor 62 where each is installed at opposite end of the ribbon supply end 52. The predetermined distance d is a distance from an axis of the ribbon supply end 52 to a line of the light source 60 and the optical sensor 62. The designer can set the predetermined distance d. For example, the predetermined distance d is set to a distance from outer layer of a group of unutilized ribbon of the ribbon dye area to the axis of the ribbon supply end 52, or the predetermined distance d is set to a distance from the other outer layer of the predetermined groups of unutilized ribbon of the ribbon dye area to the axis of the ribbon supply end 52. If the distance from the axis of the ribbon supply end 52 to the outer layer of the ribbon of the ribbon supply end 52 is greater than distance d, the unutilized ribbon is capable of performing a next printout and the printer is capable of executing the next printout normally. During this time, the light emitted from the light source 60 cannot penetrate the ribbon of the ribbon supply end 52, therefore the optical sensor 62 cannot detect the light emitted from the light source 60 and the optical sensor 62 will transmit a corresponding signal to the control module 66. After receiving the signal, the control module 66 controls the driving module 58 to move from the ribbon supply end 52 to the ribbon retrieving end 54, and the control module 66 further controls the printer to print the dye on the ribbon 70 onto the print medium 72, hence the printout process is completed.

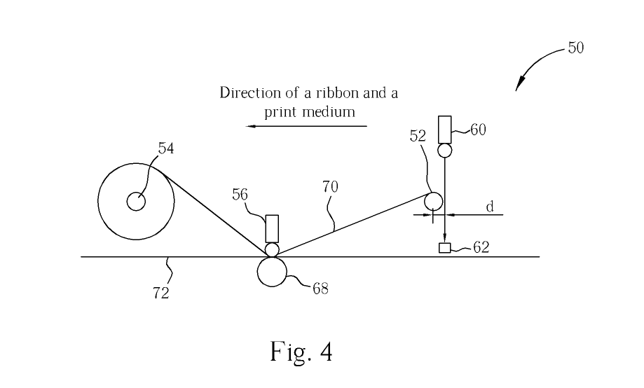

Please refer to FIG. 4. FIG. 4 illustrates an internal architectural diagram of the printer 50 without sufficient ribbon. When the distance from the axis of the ribbon supply end 52 installed to the outer layer of the ribbon of the ribbon supply end 52 is less than the distance d, the unutilized ribbon is insufficient to perform a next printout. During this time, the light emitted from the light source 60 is able to penetrate the ribbon, therefore the optical sensor 62 is able to detect the light emitted from the light source 60 and the optical sensor 62 will transmit a corresponding signal to the control module 66. After receiving the signal, the control module 66 will not control the printer to print the dye on the ribbon 70 onto the print medium 72, hence completes the printout process. Also the control module 66 will control the warning interface 64 to display a warning signal to advice the user that there is insufficient ribbon to proceed with the next printout and to replace the existing ribbon. In this way, the printer 50 will not perform a next printout when there is insufficient ribbon therefore a printing error can be avoided.

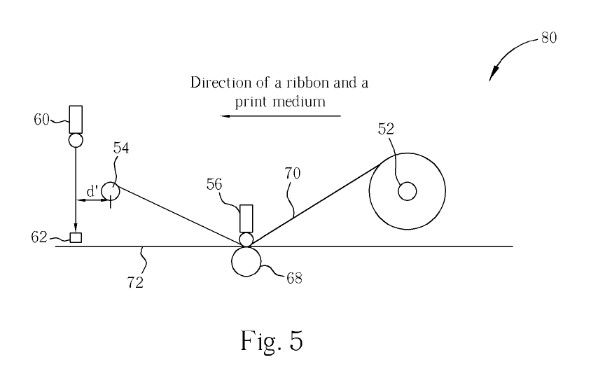

Please refer to FIG. 5. FIG. 5 illustrates an internal architectural diagram of the printer 80 with sufficient ribbon according to the second embodiment of the present invention. The difference here from the previous embodiment is that the light source 60 and the optical sensor 62 are each is installed at opposite end of the ribbon retrieving end 54. The predetermined distance d′ is a distance from an axis of the ribbon retrieving end 54 to a line of the light source 60 and the optical sensor 62. The designer can set the predetermined distance d′. For example, the predetermined distance d′ is set to a distance from the outer layer of the ribbon of the ribbon retrieving end 54 when there is a group of unutilized ribbon dye area of the ribbon supply end 52 to the axis of the ribbon retrieving end 54, or a distance from the other outer layer of the predetermined groups of unutilized ribbon of the ribbon dye area of the ribbon supply end 52 to the axis of the ribbon retrieving end 54. If the distance from the axis of the ribbon retrieving end 54 to the outer layer of the ribbon of the ribbon retrieving end 54 is less than distance d′, the unutilized ribbon is capable of performing a next printout and the printer 80 is capable of executing the next printout normally. During this time, as the light emitted from the light source 60 is able to penetrate the ribbon of the ribbon retrieving end 54, therefore the optical sensor 62 is able to detect the light emitted from the light source 60 and the optical sensor 62 will transmit a corresponding signal to the control module 66. After receiving the signal, the control module 66 controls the driving module 58 to move from the ribbon supply end 52 to the ribbon retrieving end 54 to drive the ribbon 70 from the ribbon supply end 52 to the ribbon retrieving end 54, and the control module 66 further controls the print head 56 to print the dye on the ribbon 70 onto the print medium 72, hence the printout process is completed.

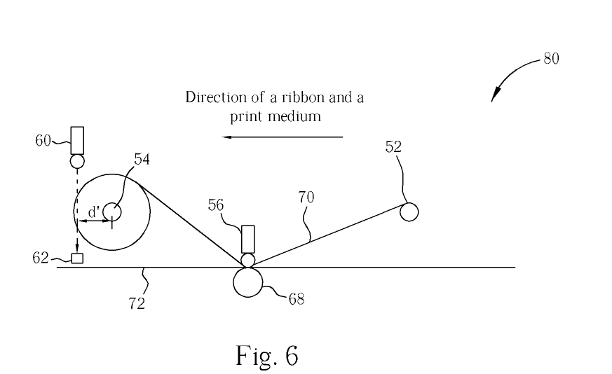

Please refer to FIG. 6. FIG. 6 illustrates an internal architectural diagram of the printer 80 with insufficient ribbon. When the distance from the axis of the ribbon retrieving end 54 installed to the end of the ribbon of the ribbon retrieving end 54 is greater than the distance d′, the unutilized ribbon is insufficient to perform a next printout. During this time, the light emitted from the light source 60 cannot to penetrate the ribbon, therefore the optical sensor 62 cannot to detect the light emitted from the light source 60 and the optical sensor 62 will transmit a corresponding signal to the control module 66. After receiving the signal, the control module 66 will not control the driving module to move from the ribbon supply end 52 to the ribbon retrieving end 54 and also the control module 66 will not control the printer to print the dye on the ribbon 70 onto the print medium 72, hence the printout process is completed. Also the control module 66 will control the warning interface 64 to display a warning signal to advice the user that there is insufficient ribbon to proceed with the next printout and to replace the existing ribbon. In this way, the printer 80 will not perform a next printout when there is insufficient ribbon therefore a printing error can be avoided.

In comparison with the prior art, the printer utilizes the combination of the light source and the optical sensor to detect the status of the ribbon and to advise the user to replace the ribbon because there is insufficient ribbon to proceed with the next printout. Therefore, the printer 80 will not perform a next printout when there is insufficient ribbon and the printing error can be avoided. The present invention overcomes the defect of the special barcode when the ribbon reaches a predetermined group number and has to stay within each dye area to be detected according to the prior art, hence the present invention increases the effective utilization of the ribbon, resulting in lower production costs of the ribbon.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A printer capable of detecting unutilized ribbon, the printer comprising:
a ribbon supply end;
a ribbon retrieving end;
a ribbon wherein two ends are installed on the ribbon supply end and the ribbon retrieving end respectively;
a print head for printing dye on the ribbon onto a print medium;
a driving module for driving the ribbon supply end and the ribbon retrieving end, and to move the ribbon from the ribbon supply end to the ribbon retrieving end;
a light source for emitting light;
an optical sensor installed in a position where the optical sensor can sense the light emitted from the light source when the thickness of the remaining ribbon on the ribbon supply end is less than a predetermined value and also the optical sensor installed in a position where the optical sensor cannot sense the light emitted from the light source when the thickness of the remaining ribbon on the ribbon supply end is greater than the predetermined value; and
a control module for controlling the printer according to whether the optical sensor can sense the light emitted from the light source.

2. The printer in claim 1 wherein the control module controls the print head such that the dye on the ribbon whether is printed onto the print medium according to whether the optical sensor sensing the light emitted from the light source.

3. The printer in claim 2 wherein the control module controls the print head not to print the dye on the ribbon onto the print medium when the optical sensor senses the light emitted from the light source.

4. The printer in claim 2 wherein the control module controls the print head to print the dye on the ribbon onto the print medium when the optical sensor cannot sense the light emitted from the light source.

5. The printer in claim 1 further comprising:
a warning interface coupled to the control module wherein the control module controls the warning interface to display a warning signal when the optical sensor senses the light emitted from the light source.

6. The printer in claim 5 wherein the warning interface is a warning light.

7. The printer in claim 1 wherein the light source is a light emitting diode (LED).

8. The printer in claim 1 wherein the printer is a thermal printer.

9. A method of controlling a printer, the method comprising the following steps:
(a) supplying a light source;
(b) an optical sensor installed in a position where the optical sensor can sense the light emitted from the light source when the thickness of the remaining ribbon on the ribbon supply end is less than a predetermined value and also the optical sensor installed in a position where the optical sensor cannot sense the light emitted from the light source when the thickness of the remaining ribbon on the ribbon supply end is greater than the predetermined value; and
(c) controlling the printer according to whether the optical sensor can sense the light emitted from the light source.

10. The method of claim 9 wherein step (c) comprises controlling the print head such that the dye on the ribbon whether is printed onto the print medium according to whether the optical sensor sensing the light emitted from the light source.

11. The method of claim 10 wherein step (c) controls the print head not to print the dye on the ribbon onto the print medium when the optical sensor senses the light emitted from the light source.

12. The method of claim 10 wherein step (c) controls the print head to print the dye on the ribbon onto the print medium when the optical sensor cannot sense the light emitted from the light source.

13. The method of claim 9 wherein step (c) controls the printer to display a warning signal when the optical sensor senses the light emitted from the light source.

14. A printer capable of detecting status of unutilized ribbon, the printer comprising:
a ribbon supply end;
a ribbon retrieving end;
a ribbon wherein two ends are installed on the ribbon supply end and the ribbon retrieving end respectively;
a print head for printing dye on the ribbon onto a print medium;
a driving module for driving the ribbon supply end and the ribbon retrieving end, and to move the ribbon from the ribbon supply end to the ribbon retrieving end;
a light source for emitting light;
an optical sensor installed in a position where the optical sensor cannot sense the light emitted from the light source when the thickness of the retrieved ribbon on the ribbon retrieving end is greater than a predetermined value and also the optical sensor installed in a position where the optical sensor can sense the light emitted from the light source when the thickness of the retrieved ribbon on the ribbon retrieving end is less than the predetermined value; and
a control module for controlling the printer according to whether the optical sensor can sense the light emitted from the light source.

15. The printer of claim 14 wherein the control module controls the print head such that the dye on the ribbon whether is printed onto the print medium according to whether the optical sensor sensing the light emitted from the light source.

16. The printer of claim 15 wherein the control module controls the print head to print the dye on the ribbon onto the print medium when the optical sensor senses the light emitted from the light source.

17. The printer of claim 15 wherein the control module controls the print head not to print the dye on the ribbon onto the print medium when the optical sensor cannot sense the light emitted from the light source.

18. The printer of claim 14 further comprising:
a warning interface coupled to the control module wherein the control module controls the warning interface to display a warning signal when the optical sensor cannot sense the light emitted from the light source.

19. The printer of claim 18 wherein the warning interface is a warning light.

20. The printer of claim 14 wherein the light source is a light emitting diode (LED).

21. The printer of claim 14 wherein the printer is a thermal printer.

22. A method of controlling a printer, the method comprising the following steps:
(a) supplying a light source;
(b) an optical sensor installed in a position where the optical sensor can sense the light emitted from the light source when the thickness of the retrieving ribbon on the ribbon retrieving end is less than a predetermined value and also the optical sensor installed in a position where the optical sensor cannot sense the light emitted from the light source when the thickness of the retrieving ribbon on the ribbon retrieving end is greater than the predetermined value; and
(c) controlling the printer according to whether the optical sensor can sense the light emitted from the light source.

23. The method of claim 22 wherein step (c) comprises controlling the print head such that the dye on the ribbon whether is printed onto the print medium according to whether the optical sensor sensing the light emitted from the light source.

24. The method of claim 23 wherein step (c) controls the print head to print the dye on the ribbon onto the print medium when the optical sensor senses the light emitted from the light source.

25. The method of claim 23 wherein step (c) controls the print head not to print the dye on the ribbon onto the print medium when the optical sensor cannot sense the light emitted from the light source.

26. The method of claim 22 wherein step (c) comprises controlling the printer to display a warning signal when the optical sensor cannot sense the light emitted from the light source.
